(19) United States
(12) Patent Application Publication
(10) Pub. No.: US 2024/0311099 A1
(43) Pub. Date: Sep. 19, 2024

(54) METHOD AND SYSTEM TO GENERATE AN INSTANT APPLICATION

(71) Applicant: Engineer.ai Corp., Salt Lake City, UT (US)

(72) Inventors: Sachin Dev Duggal, Salt Lake City, UT (US); Marco Quaglio, London (GB); Rohan Patel, London (GB)

(73) Assignee: Engineer.ai Corp., Salt Lake City, UT (US)

(21) Appl. No.: 18/298,062

(22) Filed: Apr. 10, 2023

(30) Foreign Application Priority Data
Mar. 14, 2023 (IN) 202341016792

(51) Int. Cl. G06F 8/35

(52) U.S. Cl. CPC G06F 8/35

(57) ABSTRACT

Embodiments of the present disclosure relate to a computer system and method to generate instant application. The method includes receiving a selection of one or more features and an application template and determining a linkage between each pair of features of the one or more selected features. The method also includes processing the one or more selected features based on the determined linkage and generating the instant application based on the processing and using the application template.

### CROSS REFERENCE TO PRIOR APPLICATION

This application claims the benefit of Indian Provisional Patent Application No. 20/2341016792, entitled as “Method and System for Application Prototype Generation”, filed Mar. 14, 2023, which is incorporated by reference in its entirety.

### FIELD OF THE INVENTION

This disclosure relates to software development, and more particularly to methods and systems for generating an instant application.

### BACKGROUND

Software application development takes considerable expertise and resources, from discussing an initial idea with a customer to the final stage of software application development. The amount of time required for software application development may vary from months to many years. Sometimes, when a software developer is developing a software application for the customer, it is scary to give big-time and cost commitments without seeing how the new application will work. There may also be situations in which customer expectations may differ for the software application developed even by experienced developers.

Accordingly, there is a need in the art to generate a software application prototype well before the developers initiate the work and deliver the final software application.

### SUMMARY

The disclosed subject matter includes systems, methods, and computer-readable storage mediums for generating a prototype of an application. The method includes receiving an entity specification. The entity specification includes one or more features and application information. The method further includes estimating a linkage for each pair of features of the one or more features and generating the prototype of the application based on the estimated linkage between each pair of features and using the application information.

Another general aspect is a computer system to generate a prototype of an application. The computer system includes a memory and a processor coupled to the memory. The processor is configured to receive an entity specification. The entity specification includes one or more features and application information. The processor is further configured to estimate a linkage for each pair of features of the one or more features and generate the prototype of the application based on the estimated linkage between each pair of features and using the application information.

An exemplary embodiment is a computer readable storage medium having data stored therein representing software executable by a computer. The software includes instructions that, when executed, cause the computer readable storage medium to perform receiving an entity specification. The entity specification includes one or more features and application information. The instructions may further cause the computer readable storage medium to perform estimating a linkage for each pair of features of the one or more features and generating the prototype of the application based on the estimated linkage between each pair of features and using the application information.

Another general aspect is a method for recommending one or more launch screens for an application. The method includes receiving a buildcard. The buildcard includes an application template and one or more features. The method also includes determining a hierarchical relationship between the one or more features and recommending the one or more launch screens for the application based on the determined hierarchical relationship and the application template.

An exemplary embodiment is a computer system to recommend one or more launch screens for an application. The computer system includes a memory and a processor coupled to the memory. The processor is configured to receive a buildcard. The buildcard includes an application template and one or more features. The processor is also configured to determine a hierarchical relationship between the one or more features and recommend the one or more launch screens for the application based on the determined hierarchical relationship and the application template.

Another general aspect is a computer readable storage medium having data stored therein representing software executable by a computer. The software includes instructions that, when executed, cause the computer readable storage medium to perform receiving a buildcard. The buildcard includes an application template and one or more features. The instructions may further cause the computer readable storage medium to perform determining a hierarchical relationship between the one or more features and recommending the one or more launch screens for the application based on the determined hierarchical relationship and the application template.

Another exemplary embodiment is a method for generating an instant application. The method includes receiving a selection of one or more features and an application template and determining a linkage between each pair of features of the one or more selected features. The methods also includes processing the one or more selected features based on the determined linkage and generating the prototype of the application based on the processing and using the application template.

Another general aspect is a computer system to generate an instant application. The computer system includes a memory and a processor coupled to the memory. The processor is configured to receive a selection of one or more features and an application template and determine a linkage between each pair of features of the one or more selected features. The processor is also configured to process the one or more selected features based on the determined linkage and generate the prototype of the application based on the processing and using the application template.

An exemplary embodiment is a computer readable storage medium having data stored therein representing software executable by a computer. The software includes instructions that, when executed, cause the computer readable storage medium to perform receiving a selection of one or more features and an application template and determining a linkage between each pair of features of the one or more selected features. The instructions may further cause the computer readable storage medium to perform processing the one or more selected features based on the determined linkage and generating the prototype of the application based the processing and using the application template.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic for an embodiment of a prototype generation system of the disclosed subject matter.

FIG. 7 is a flow diagram 700 for an embodiment of the process of generating a prototype of an application.

FIG. 8A is a flow diagram for another embodiment of the process of generating a prototype of an application.

FIG. 8B is a flow diagram for an embodiment of the process of recommending one or more launch screens for an application.

FIG. 8C is a flow diagram for an embodiment of the process of generating an instant application.

FIG. 9A is an illustration of a screen flow view of an exemplary application.

FIG. 9B is an illustration of a subset of screen flow view of an exemplary application.

FIG. 10A is an illustration of a screen flow view of an exemplary application for web platform.

FIG. 10B is an illustration of a subset of screen flow view of FIG. 10A.

FIG. 11A is an illustration of a subset of screen flow view of an exemplary application for web platform.

FIG. 11B is an illustration of a prototype represented as a graph for an exemplary application.

FIGS. 12A-12B are illustrations of launch screens for two different exemplary applications.

### DETAILED DESCRIPTION

The disclosed subject matter comprises systems and methods for generating a prototype of an application. The method includes receiving an entity specification. The entity specification includes one or more features and application information. The method further includes estimating a linkage for each pair of features of the one or more features and generating the prototype of the application based on the estimated linkage between each pair of features and using the application information.

Embodiments, of the present disclosure, will now be described with reference to the accompanying drawing. Embodiments are provided to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, apparatus structures, and techniques are not described in detail.

The terminology used, in the present disclosure, is to explain a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

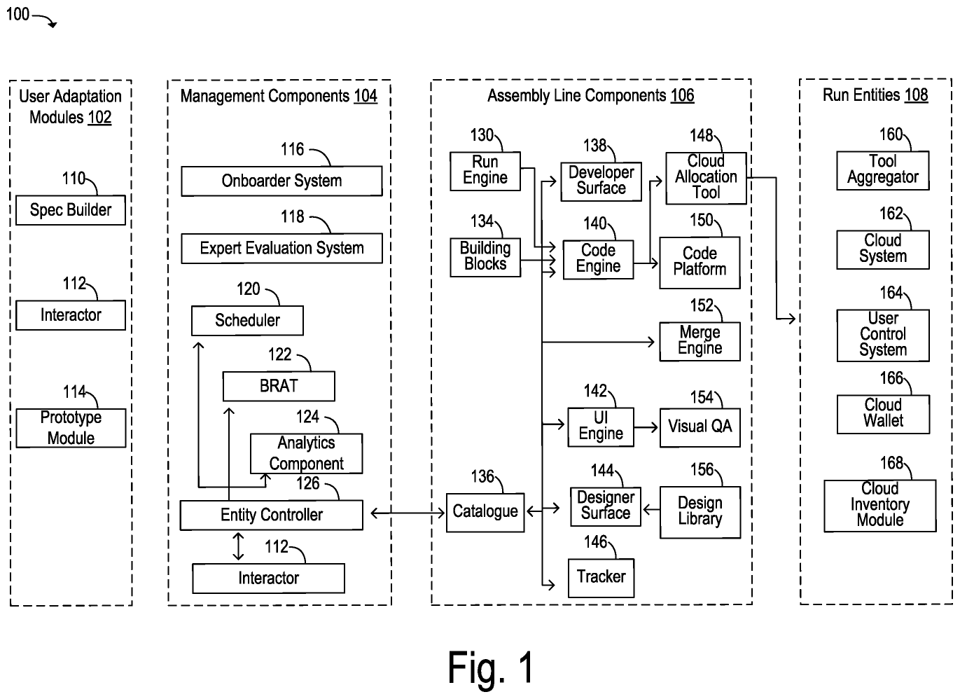

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent AI conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100 based on the specific needs of the user.

The user adaptation modules 102 may include specification builder 110, an interactor 112 system, and the prototype module 114. They may be used to guide a user through a process of building software and managing a software project. The specification builder 110, The Interactor 112 system, and the prototype module 114 may be used concurrently and/or link to one another. For instance, the specification builder 110 may accept user specifications that are generated in the Interactor 112 system. The prototype module 114 may utilize computer generated specifications that are produced in the specification builder 110 to create a prototype for various features. Further, the interactor 112 system may aid a user in implementing all features in the specification builder 110 and the prototype module 114.

The specification builder 110 converts user supplied specifications into specifications that can be automatically read and implemented by various objects, instances, or entities of the software building system 100. The machine-readable specifications may be referred to herein as a build card. In an example of use, the specification builder 110 may accept a set of features, platforms, etc., as input and generate a machine-readable specification for that project. The specification builder 110 may further use one or more machine learning algorithms to determine a cost and/or timeline for a given set of features. In an example of use, The specification builder 110 may determine potential conflict points and factors that will significantly affect cost and timeliness of a project based on training data. For example, historical data may show that a combination of various building block components create a data transfer bottleneck. The specification builder 110 may be configured to flag such issues.

The interactor 112 system is an AI powered speech and conversational analysis system. It converses with a user with a goal of aiding the user. In one example, the Interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases.

In an exemplary embodiment, the NLP implemented by the interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to minimize the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a most likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with valuable critique and provide the onboarding system 116 with metrics with it can use to allocate the experts on future tasks.

Scheduler 120 keeps track of overall progress of a project and provides experts with job start and job completion estimates. In a complex project, some expert developers may be required to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation Tool (BRAT 122) is capable of generating optimal developer assignments for every available parallel workstream across multiple projects. BRAT 122 system allows expert developers to be efficiently managed to minimize cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to the scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, Visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specification. The term build cards, as used herein, refer to machine readable specifications that are generated by the specification builder 110, which may convert user specifications into a computer readable specification that contains the user specifications and a format that can be implemented by an automated process with minimal intervention by expert developers.

The computer readable specification is constructed with building block components 134, which are reusable code components. The building block components 134 may be pretested code components that are modular and safe to use. In an exemplary embodiment, every building block component 134 consists of two sections-core and custom. Core sections comprise the lines of code which represent the main functionality and reusable components across computer readable specification. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may essentially work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the needed throughput based on the volume of builds coming in through a queue system. This stateless architecture may also enable support for multiple languages in a plug & play manner.

The cloud allocation tool 148 manages cloud computing that is associate with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

Visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by the scheduler 120 so they can be reviewed by expert developers.

In an exemplary embodiment, the visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building blocks 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for needed services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, the specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over every feature of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user need only set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the entire lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

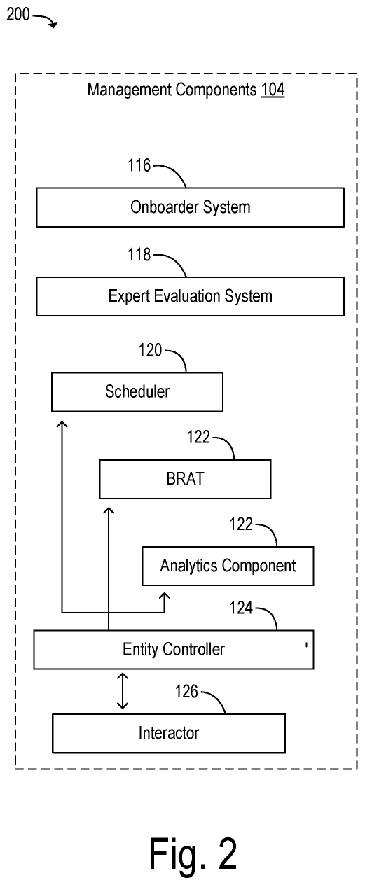

Referring to FIG. 2. FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all the computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into the scheduler 120 to determine a timeline for jobs to be completed by developer experts and designers. The BRAT 122 system may be leveraged to score and rank experts for jobs in the scheduler 120. A user may interact with the various entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

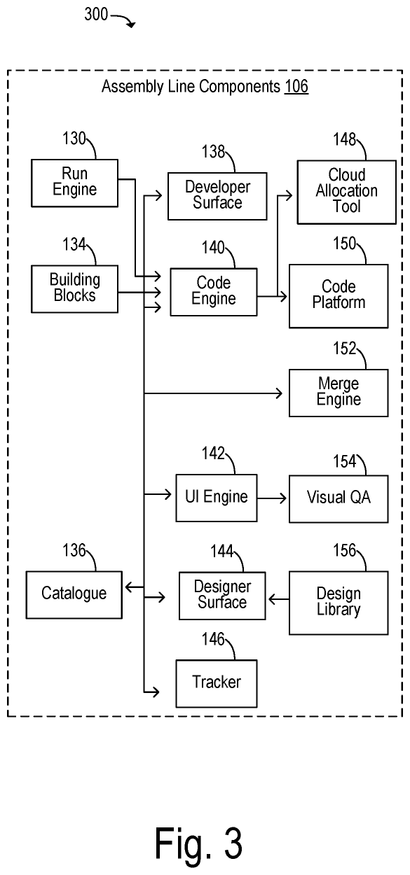

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The computer readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The Scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building blocks, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel-to-pixel comparison and logs any discrepancies to be evaluated by an expert developer.

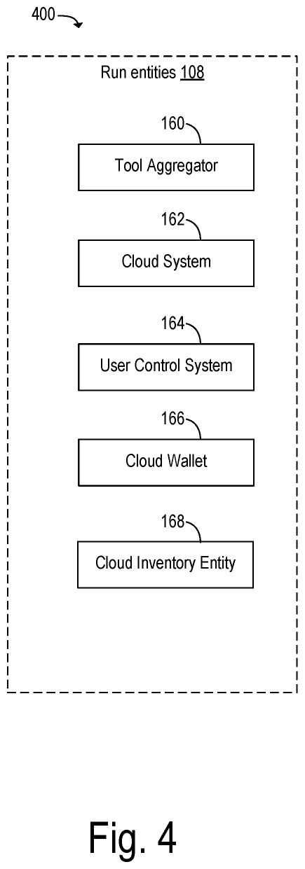

Referring to FIG. 4, FIG. 4 is a schematic 400 illustrating an embodiment of the run entities 108 of the software building system. The run entities 108 provides a user with 3^{rd} party tools and services, inventory management, and cloud services in a scalable system that can be automated to manage a software project. In an exemplary embodiment, the run entities 108 is a cloud-based system that provides a user with all tools necessary to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into the computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

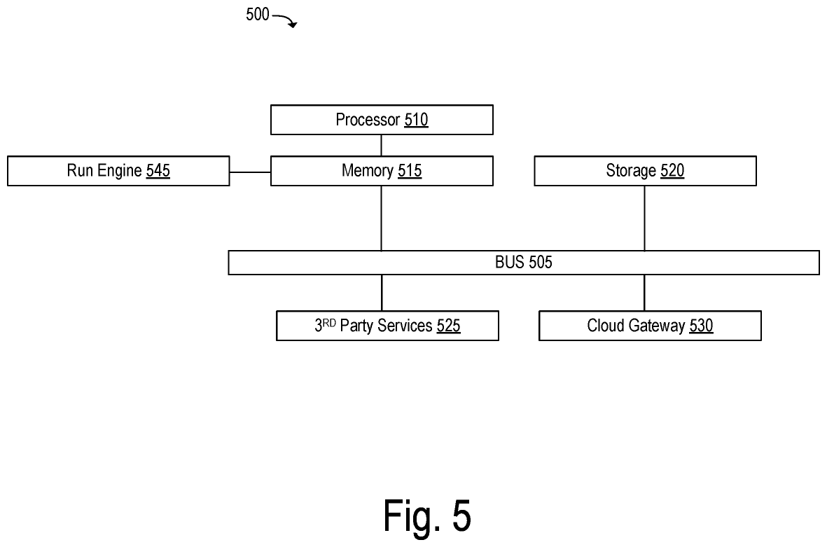

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, one or more processors 510 connected to a memory 515, and at least one storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The memory 515 may store one or more applications that run time. For example the memory 515 may store the run engine 545 of the disclosed subject matter. An exemplary embodiment, run engine 545 may facilitate messages between various components of an application. For example, one or more building blocks of an application may transmit messages via the run engine 545. The memory 515, coupled to the processor 510, facilitates execution of messages in the application.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives. In various embodiments, the software application may be stored in the storage 520. To run the application, a user may execute a command to transfer the application from the storage to the memory to run the application.

The computing system 500 may connect to other computing systems in the performance of a software project. For instance, the computing system 500 may send and receive data from 3^{rd} party services such as Office 365 and Adobe. Similarly, users may access the computing system 500 via a cloud gateway 530. For instance, a user on a separate computing system may connect to the computing system 500 to access data, interact with the run entities 108, and even use 3^{rd} party services 525 via the cloud gateway.

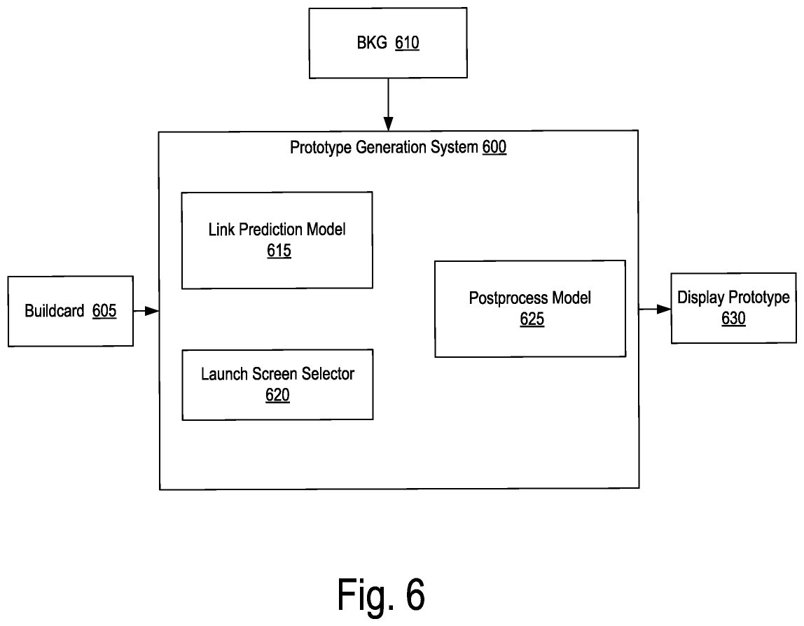

Referring to FIG. 6, FIG. 6 is a schematic for an embodiment of a prototype generation system 600 of the disclosed subject matter. The prototype generation system 600 facilitates the generation of software application prototype based on input from a buildcard 605 and a Builder Knowledge Graph (BKG) 615.

The information provided by a customer to develop the software application is converted into a machine-readable specifications. The machine-readable specification may be referred to herein as the buildcard 605. The buildcard 605 includes one or more features selected by a customer to develop the software application. In one example, the one or more features can be a login feature, a sign up feature, a payment processing feature, and so on. The buildcard 605 also includes application information selected by a customer to develop the software application. The application information is also known as application template which gives the information about a design of the software application (or) an interface of the software application. In one embodiment, the application template can be a custom template when the user provides his/her inputs for the design different from existing software applications. In another embodiment, the application template can be a pre-defined template taken from the existing software application. For example, if the customer wants to develop a software application related to an e-commerce platform, the customer can make a selection template or design similar to one of the popular e-commerce platforms available. The buildcard 605 also includes a cost and/or timeline required for the software development based on the one or more features and the application information.

The builder knowledge graph (BKG) 610 includes a database based on information from one or more historical projects developed and the information fed by one or more users/admins of the BKG 610. In one embodiment, the database can be a graph database that stores nodes and relationships instead of tables or documents. In one example, the nodes can be features, and the relationships can be linkage between the features. In another embodiment, the database can be a traditional database that stores data in tables or documents. The database also includes master templates, master feature images, one or more historical buildcards, one or more historical buildcard feature images, one or more historical buildcard features, one or more historical buildcard hotspots, one or more clickable items, application details, and so on.

The prototype generation system 600 includes one or more blocks or modules known as a link prediction module 615, a launch screen selector 620, and a postprocess module 625. As user herein, the term module refers to an application-specific integrated circuit (ASIC), an electronic circuit, a processor (shared, dedicated, or group) and memory that execute one or more software or firmware programs, a combination logic circuit, and/or other suitable components that provide the described functionality.

The link prediction module 615 is configured to receive one or more features and an application template selected by the customer from the buildcard 605. The link prediction module 615 is configured to estimate a linkage between each pair of features of the one or more features. In order to estimate the linkage between each pair of features, the link prediction module 615 is configured to initially retrieve the historical data from the database coupled to the BKG 610. Upon retrieving the historical data, the link prediction module 615 is configured to select an appropriate machine learning model from a plurality of machine learning models. In one embodiment, the machine learning model can be a variant of Light Gradient Boosting (LGB) model. The link predication module 615 is then configured to input the historical data and each pair of features along with additional inputs to the selected machine learning model. Based on an output of the selected machine learning model, the link prediction module 615 is configured to estimate the linkage between each pair of features. In one embodiment, in order to select the machine learning model, the link prediction module 615 is configured to input one or more inputs and the retrieved data to each of the plurality of machine learning model by assigning a weightage factor to each of the one or more inputs. Further, the link prediction module 615 is configured to determine values of one or more output parameters, wherein at least one parameter of the one or more output parameters includes an F1 score. Based on one or more output parameter values, the link prediction module 615 selects the machine learning model for estimating the linkage. In one embodiment, the one or more inputs can be the application template, the one or more features, a probability of correlation between a pair of features, and an existence of relationship between each pair of features in the database. In one embodiment, the existence of relationship between each pair of features may be stored in Content Management System also known as CMS.

The launch screen selector 620 is coupled to the link prediction model 615. The launch screen selector 620 is configured to recommend and/or select one or more launch screens or a start screen feature for the application. In order to recommend and/or select the one or more launch screens or the start screen feature for the application, the launch screen selector 620 is configured to receive a hierarchical relationship between the one or more features from the link prediction module 615.

In one embodiment, in order to recommend the one or more launch screens for the application, the launch screen selector 620 is configured to identify a type of application based on the application template. In one example, the type of application can be financial, e-commerce, entertainment, e-learning, and so on. Upon identifying the type of application, the launch screen selector 620 is configured to input the type of application and the one or more features to a first machine learning model and recommend the one or more launch screens for the application based on an output of the first machine learning model.

In one embodiment, to recommend the one or more launch screens for the application, the launch screen selector 620 is configured to extract one or more launch screens selected for historical applications, wherein the historical applications are selected based on the application template. Upon extracting one or more launch screens selected for historical applications, the launch screen selector 620 is configured to compare the features with selected one or more launch screens and recommend the one or more launch screens for the application based on the comparison.

In one embodiment, to recommend the one or more launch screens for the application, the launch screen selector 620 is configured to extract keywords for one or more launch screens selected for historical applications, wherein the historical applications are selected based on the application template. Upon extracting the keywords for the one or more launch screens selected for historical applications, the launch screen selector 620 is configured to compare the features with selected one or more launch screens and recommend the one or more launch screens for the application based on the comparison.

The postprocess module 625 is coupled to the link prediction module 615 and the launch screen selector 620. The postprocess module 625 is configured to process the one or more selected features based on the determined linkage from the link prediction model. In one embodiment, the step of processing the one or more selected features based on the determined linkage by the post process model includes classifying the one or more features as unconnected features and connected features. Further, the step of processing also includes identifying one or more potential hotspots in the one or more unconnected features and predicting the linkage for the one or more unconnected features with the connected features based on the one or more identified potential hotspots.

In one embodiment, in order to predict the linkage for the one or more unconnected features, the postprocess module 625 is configured to retrieve one or more clickable items mapped to the identified one or more potential hotspots, wherein the one or more clickable items are included in the one or more features and predict the linkage for the one or more unconnected features with the connected features based on the retrieved one or more clickable items.

In one embodiment, in order to predict the linkage for the one or more unconnected features, the postprocess module 625 is configured to input the identified one or more potential hotspots to a first machine learning model and estimate one or more clickable items as an output of the first machine learning model, wherein the one or more clickable items are included in the one or more features. The postprocess module 625 is then configured to predict the linkage for the one or more unconnected features with the connected features based on the estimated one or more clickable items.

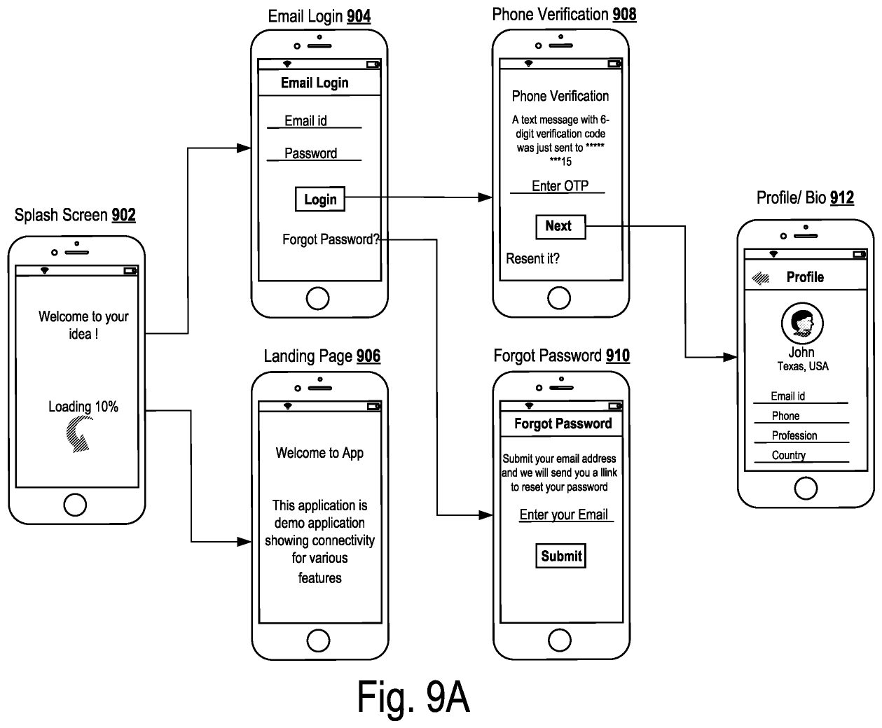

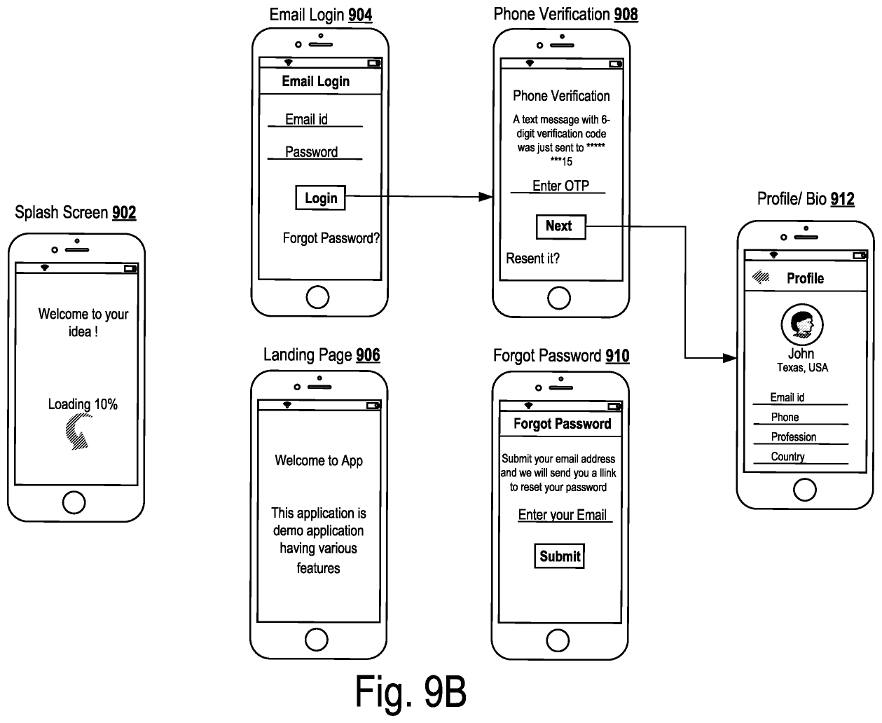

The display prototype 630 is coupled to an output of the prototype generation system 600. The Display prototype 630 generates the prototype and display the generated prototype of the software application to be developed. In one embodiment, the prototype of the software application is generated and displayed as a flow of screens connected as per the estimated linkages as shown in FIG. 9A. In another embodiment, the prototype of the software application is displayed as a graph having nodes as features and relationship between nodes as the linkage between the features as shown in 11A.

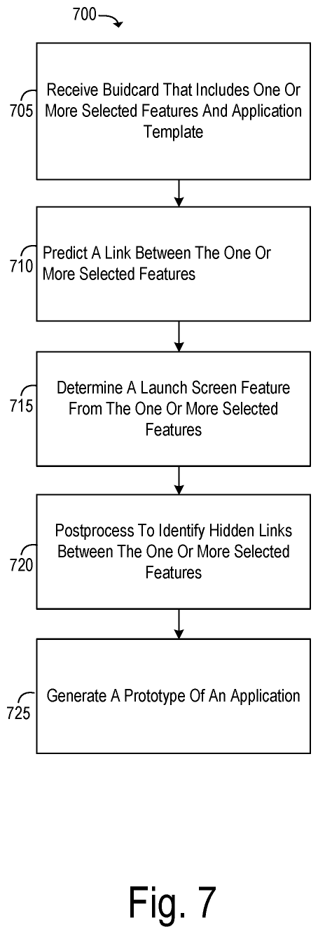

Referring to FIG. 7, FIG. 7 is a flow diagram 700 for an embodiment of a process of generating a prototype of an application. The process may be utilized by one or more modules in the prototype generation system 600 for generating the prototype of an application. The order in which the process/method 700 is described is not intended to be construed as a limitation, and any number of the described method blocks can be combined in any order to implement the method 700. Additionally, individual blocks may be deleted from the method 700 without departing from the spirit and scope of the subject matter described herein. Furthermore, the method 700 can be implemented in any suitable hardware, software, firmware, or combination thereof.

At step 705, the process may receive the buildcard. The buildcard 605 includes one or more features selected by the customer for the development of the software application. In one example, the one or more features can be a login feature, a sign up feature, a payment processing feature, and so on. The buildcard 605 also includes application information selected by a customer for the development of the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop a software application related to e-commerce platform, the customer can make a selection of a template or design similar to one of the popular e-commerce platforms available. The buildcard 605 also includes a cost and/or timeline required for the software development based on the one or more features and the application information.

At step 710, the process may predict a link between the one or more selected features. The link prediction module 615 is configured to receive one or more features and an application template selected by the customer from the buildcard 605. The link prediction module 615 is configured to estimate a linkage between each pair of features of the one or more features. In order to estimate the linkage between each pair of features, the link prediction module 615 is configured to initially retrieve the historical data from the database coupled to the BKG 610. Upon retrieving the historical data, the link prediction module 615 is configured to select an appropriate machine learning model from a plurality of machine learning models. In one embodiment, the machine learning model can be a variant of Light Gradient Boosting (LGB) model. The link predication module 615 is then configured to input the historical data and each pair of features to the selected machine learning model. Based on the output of the selected machine learning model, the link prediction module 615 is configured to estimate the linkage between each pair of features. In one embodiment, in order to select the machine learning model, the link prediction module 615 is configured to input one or more inputs and the retrieved data to each of the plurality of machine learning model by assigning a weightage factor to each of the one or more inputs. Further, the link prediction module 615 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 715, the process may determine one or more launch screen features from the one or more selected features. The launch screen selector 620 is coupled to the link prediction model 615. The launch screen selector 620 is configured to recommend and/or select one or more launch screen or a start screen feature for the application. In order to recommend and/or select one or more launch screen or a start screen feature for the application, the launch screen selector is configured to receive a hierarchical relationship between the one or more features from the link prediction model. In one embodiment, to recommend the one or more launch screen for the application, the launch screen selector 620 is configured identify a type of application based on the application template. In one example, the type of application can be financial application, e-commerce application, entertainment application, and e-learning application. Upon identifying the type of application, the launch screen selector 620 is configured to input the type of application and the one or more features to a first machine learning model and recommend the one or more launch screens for the application based on an output of the first machine learning model. model. In one embodiment, in order to recommend the one or more launch screen for the application, the launch screen selector 620 is configured extract one or more launch screens selected for historical applications, wherein the historical applications are selected based on the application template. Upon extracting one or more launch screens selected for historical applications, the launch screen selector 620 is configured to compare the one or more features with selected one or more launch screens and recommend the one or more launch screen for the application based on the comparison. In one embodiment, in order to recommend the one or more launch screen for the application, the launch screen selector 620 is configured extract keywords for one or more launch screens selected for historical applications, wherein the historical applications are selected based on the application template. Upon extracting the keywords for the one or more launch screens selected for historical applications, the launch screen selector 620 is configured to compare the one or more features with selected one or more launch screens and recommend the one or more launch screen for the application based on the comparison.

At step 720, the process may identify one or more hidden links between the selected features. In one embodiment, the postprocess module 625 is configured to process the one or more selected features based on the determined linkage from the link prediction module 615. In one embodiment, the step of processing the one or more selected features based on the determined linkage by the postprocess module 625 includes classifying the one or more features as unconnected features and connected features. Further, the step of processing also includes identifying one or more potential hotspots in the one or more unconnected features and predicting the linkage for the one or more unconnected features with the one or more features based on the one or more identified potential hotspots. In one embodiment, in order to predict the linkage for the one or more unconnected features, the postprocess module 625 is configured to retrieve one or more clickable items mapped to the identified one or more potential hotspots, wherein the one or more clickable items are included in the one or more features and predict the linkage for the one or more unconnected features with the one or more features based on the retrieved one or more clickable items. In one embodiment, in order to predict the linkage for the one or more unconnected features, the postprocess module 625 is configured to input the identified one or more potential hotspots to a first machine learning model and estimate one or more clickable items as an output of the first machine learning model, wherein the one or more clickable items are included in the one or more features. The postprocess module 625 is then configured to predict the linkage for the one or more unconnected features with the one or more features based on the estimated one or more clickable items.

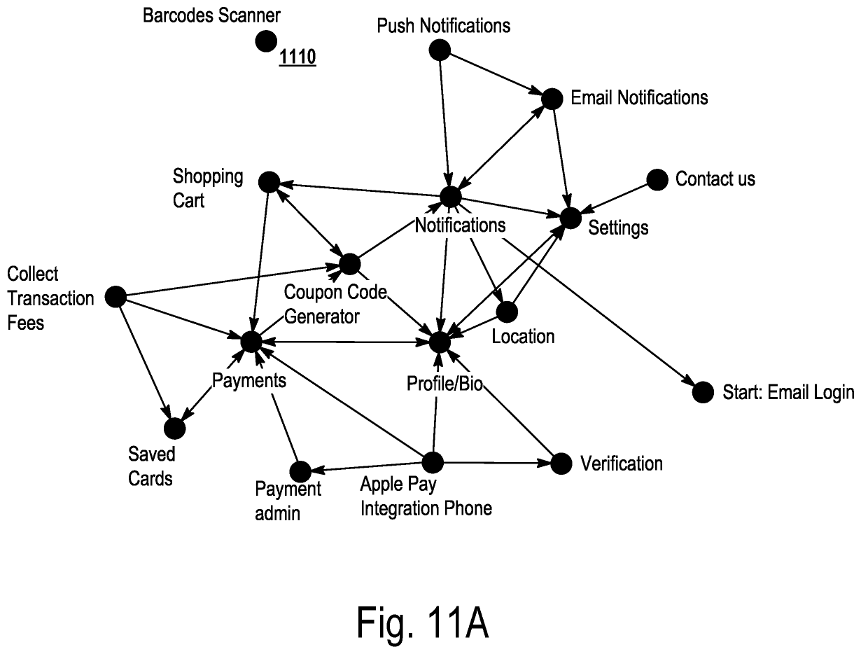

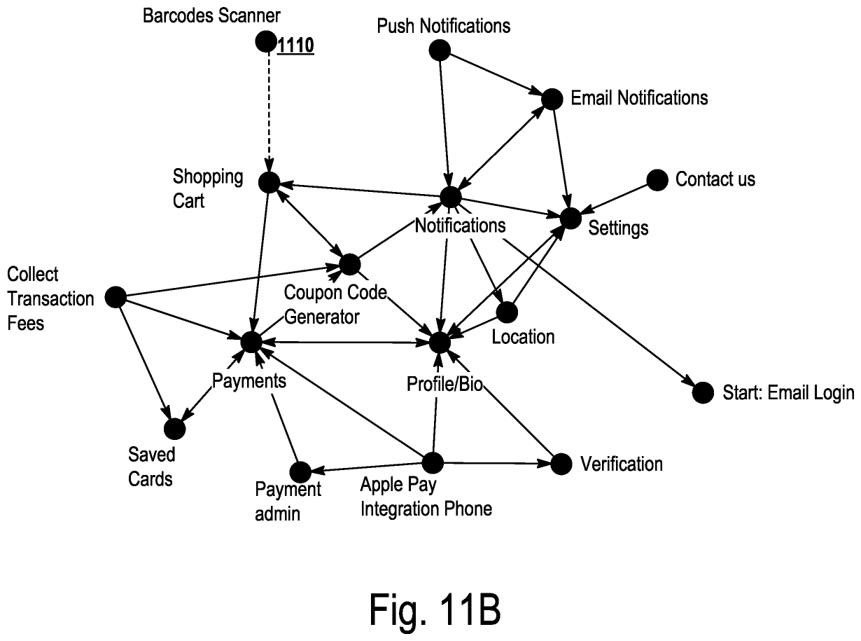

At step 725, the process may generate the prototype of the application using an output of the postprocess module 625. In one embodiment, the prototype of the software application is generated and displayed as a flow of screens connected as per the estimated linkages shown in FIG. 9A. In another embodiment, the prototype of the software application is displayed as a graph having nodes as features and relationship between the nodes as a linkage as shown in FIG. 11A.

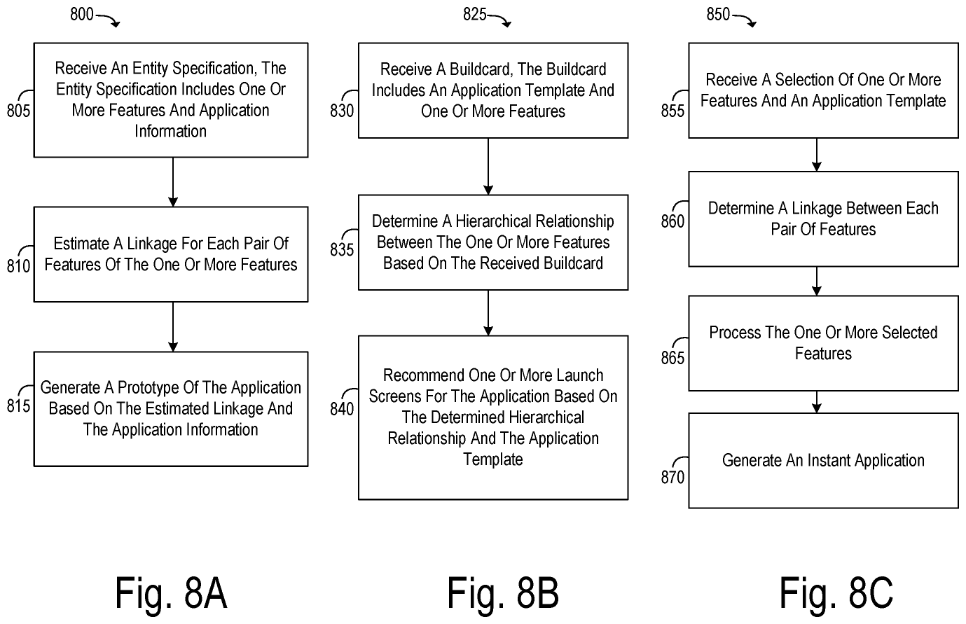

Referring to FIG. 8A, FIG. 8A is a flow diagram 800 for an embodiment of a process of generating a prototype of an application. The process may be utilized by one or more modules in the prototype generation system 600 for generating the prototype of an application. The order in which the process/method 800 is described is not intended to be construed as a limitation, and any number of the described method blocks can be combined in any order to implement the method 800. Additionally, individual blocks may be deleted from the method 800 without departing from the spirit and scope of the subject matter described herein. Furthermore, the method 800 can be implemented in any suitable hardware, software, firmware, or combination thereof.

At step 805, the process may receive an entity specification. The entity specification includes one or more features selected by a customer for the development of the software application. In one example, the one or more features can be a login feature, a sign up feature, a payment processing feature, and so on. The entity specification also includes application information selected by a customer for the development of the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop an software application related to e-commerce platform, the customer can make a selection template or design similar to one of the popular e-commerce platforms available. The entity specification also includes a cost and/or timeline required for the software development based on the one or more features and the application information.

At step 810, the process may predict a link between the one or more selected features. The link prediction module 615 is configured to receive one or more features and an application template selected by the customer from the buildcard 605. The link prediction module 615 is configured to estimate a linkage between each pair of features of the one or more features. In order to estimate the linkage between each pair of features, the link prediction module 615 is configured to initially retrieve the historical data from the database coupled to the BKG 610. Upon retrieving the historical data, the link prediction module 615 is configured to select an appropriate machine learning model from a plurality of machine learning models. In one embodiment, the machine learning model can be a variant of Light Gradient Boosting (LGB) model. The link predication module 615 is then configured to input the historical data and each pair of features to the selected machine learning model. Based on the output of the selected machine learning model, the link prediction module 615 is configured to estimate the linkage between each pair of features. In one embodiment, in order to select the machine learning model, the link prediction model is configured to input one or more inputs and the retrieved data to each of the plurality of machine learning model by assigning a weightage factor to each of the one or more inputs. Further, the link prediction module 615 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 815, the process may generate a prototype of an application using an output of the link prediction module 615. In one embodiment, the prototype of the software application is generated and displayed as a flow of screens connected as per the estimated linkages shown in FIG. 9A. In another embodiment, the prototype of the software application is displayed as a graph having nodes as a features and relationship between the nodes as a linkage as shown in FIG. 11A.

Referring to FIG. 8B, FIG. 8B is a flow diagram 825 for an embodiment of a process of recommending one or more launch screens for the application. The process may be utilized by one or more modules in the prototype generation system 600 for generating the prototype of an application. The order in which the process/method 825 is described is not intended to be construed as a limitation, and any number of the described method blocks can be combined in any order to implement the method 825. Additionally, individual blocks may be deleted from the method 825 without departing from the spirit and scope of the subject matter described herein. Furthermore, the method 825 can be implemented in any suitable hardware, software, firmware, or combination thereof.

At step 830, the process may receive a buildcard. The buildcard 605 includes one or more features selected by a customer for the development of the software application. In one example, the one or more features can be a login feature, a sign up feature, a payment processing feature, and so on. The buildcard 605 also includes application information selected by a customer for the development of the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop an software application related to e-commerce platform, the customer can make a selection template or design similar to one of the popular e-commerce platforms available. The buildcard 605 also includes a cost and/or timeline required for the software development based on the one or more features and the application information.

At step 835, the process may determine a hierarchal relationship between the one or more selected features. The link prediction module 615 is configured to receive one or more features and an application template selected by the customer from the buildcard 605. The link prediction module 615 is configured to determine a linkage between each pair of features of the one or more features. In order to determine the linkage between each pair of features, the link prediction module 615 is configured to initially retrieve the historical data from the database coupled to the BKG 610. Upon retrieving the historical data, the link prediction module 615 is configured to select an appropriate machine learning model from a plurality of machine learning models. In one embodiment, the machine learning model can be a variant of Light Gradient Boosting (LGB) model. The link predication module 615 is then configured to input the historical data and each pair of features to the selected machine learning model. Based on the output of the selected machine learning model, the link prediction module 615 is configured to estimate the linkage between each pair of features. In one embodiment, in order to select the machine learning model, the link prediction module 615 is configured to input one or more inputs and the retrieved data to each of the plurality of machine learning model by assigning a weightage factor to each of the one or more inputs. Further, the link prediction module 615 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 840, the process may recommend one or more launch screen features from the one or more selected features. The launch screen selector 620 is coupled to the link prediction model 615. The launch screen selector 620 is configured to recommend and/or select one or more launch screens or a start screen feature for the application. In order to recommend and/or select one or more launch screens or a start screen feature for the application, the launch screen selector is configured to receive a hierarchical relationship between the one or more features from the link prediction model. In one embodiment, in order to recommend the one or more launch screen for the application, the launch screen selector 620 is configured identify a type of application based on the application template. In one example, the type of application can be financial application, e-commerce application, entertainment application, and e-learning application. Upon identifying the type of application, the launch screen selector 620 is configured to input the type of application and the one or more features to a first machine learning model and recommend the one or more launch screens for the application based on an output of the first machine learning model. model. In one embodiment, in order to recommend the one or more launch screens for the application, the launch screen selector 620 is configured to extract one or more launch screens selected for historical applications, wherein the historical applications are selected based on the application template. Upon extracting one or more launch screens selected for historical applications, the launch screen selector 620 is configured to compare the one or more features with selected one or more launch screens and recommend the one or more launch screens for the application based on the comparison. In one embodiment, in order to recommend the one or more launch screens for the application, the launch screen selector 620 is configured extract keywords for one or more launch screens selected for historical applications, wherein the historical applications are selected based on the application template. Upon extracting the keywords for the one or more launch screens selected for historical applications, the launch screen selector 620 is configured to compare the one or more features with selected one or more launch screens and recommend the one or more launch screens for the application based on the comparison.

Referring to FIG. 8C, FIG. 8C is a flow diagram 850 for an embodiment of a process of generating an instant application. The process may be utilized by one or more modules in the prototype generation system 600 for generating the prototype of an application. The order in which the process/method 850 is described is not intended to be construed as a limitation, and any number of the described method blocks can be combined in any order to implement the method 850. Additionally, individual blocks may be deleted from the method 850 without departing from the spirit and scope of the subject matter described herein. Furthermore, the method 850 can be implemented in any suitable hardware, software, firmware, or combination thereof.

At step 855, the process may receive one or more features selected by a customer for the development of the software application. In one example, the one or more features can be a login feature, a sign up feature, a payment processing feature, and so on. The process also receives application information selected by a customer to develop the software application. The application information is also known as application template which gives the information about a design of the software application (or) an interface of the software application. In one embodiment, the application template can be a custom template when the user provides his/her inputs for the design which is different from already existing software applications. In other embodiment, the application template can be a pre-defined template taken from the already existing software application. For example, if the customer wants to develop an software application related to e-commerce platform, the customer can make a selection template or design similar to one of the popular e-commerce platforms available. The buildcard 605 also includes a cost and/or timeline required for the software development based on the one or more features and the application information.

At step 860, the process may determines a link between the one or more selected features. The link prediction module 615 is configured to receive one or more features and an application template selected by the customer from the buildcard 605. The link prediction module 615 is configured to estimate a linkage between each pair of features of the one or more features. In order to estimate the linkage between each pair of features, the link prediction module 615 is configured to initially retrieve the historical data from the database coupled to the BKG 610. Upon retrieving the historical data, the link prediction module 615 is configured to select an appropriate machine learning model from a plurality of machine learning models. In one embodiment, the machine learning model can be a variant of Light Gradient Boosting (LGB) model. The link predication module 615 is then configured to input the historical data and each pair of features to the selected machine learning model. Based on the output of the selected machine learning model, the link prediction module 615 is configured to estimate the linkage between each pair of features. In one embodiment, in order to select the machine learning model, the link prediction module 615 is configured to input one or more inputs and the retrieved data to each of the plurality of machine learning model by assigning a weightage factor to each of the one or more inputs. Further, the link prediction module 615 is configured to determine a value of one or more parameters, wherein at least parameter of the one or more parameters includes a F1 score; and select the machine learning model based on the value of the one or more parameters for estimating the linkage. In one embodiment, the one or more inputs can be the application template, the one or more features, a probability of correlation between a pair of features, and the determined existence of relationship between the pair of features.

At step 865, the process may process one or more selected features to identify one or more hidden links between the selected features. In one embodiment, the postprocess module 625 is configured to process the one or more selected features based on the determined linkage from the link prediction module 615. In one embodiment, the step of processing the one or more selected features based on the determined linkage by the post process model includes classifying the one or more features as unconnected features and connected features. Further, the step of processing also includes identifying one or more potential hotspots in the one or more unconnected features and predicting the linkage for the one or more unconnected features with the one or more features based on the one or more identified potential hotspots. In one embodiment, in order to predict the linkage for the one or more unconnected features, the postprocess module 625 is configured to retrieve one or more clickable items mapped to the identified one or more potential hotspots, wherein the one or more clickable items are included in the one or more features and predict the linkage for the one or more unconnected features with the one or more features based on the retrieved one or more clickable items. In one embodiment, in order to predict the linkage for the one or more unconnected features, the postprocess module 625 is configured to input the identified one or more potential hotspots to a first machine learning model and estimate one or more clickable items as an output of the first machine learning model, wherein the one or more clickable items are included in the one or more features. The postprocess module 625 is then configured to predict the linkage for the one or more unconnected features with the one or more features based on the estimated one or more clickable items.

At step 870, the process may generate an instant application using an output of the postprocess module 625. In one embodiment, the instant application is generated and displayed as a flow of screens connected as per the estimated linkages shown in FIG. 9A. In another embodiment, the instant software application is displayed as a graph having nodes as features and relationship between the nodes as a linkage between the features as shown in FIG. 11A.

Referring to FIG. 9A, FIG. 9A is an illustration of a screen flow view of an exemplary application. The screen flow view is an output of the prototype generation system 600. The customer has selected 6 features that includes a splash screen 902, a email login 904, a landing page 906, a phone verification 908, a forgot password 910, and a profile/bio 912 for building an application. One or more inputs from the customer as a buildcard having 6 features and historical data from the database coupled to the BKG are provided to the prototype generation system 600. Initially, the inputs are provided to the link prediction module 615 of the prototype generation system 600 to predict a linkage between each pair of the 6 features. The link prediction module 615 initially selects a machine learning model that is required to predict the linkage between each pair of the 6 features. Upon selecting the machine learning model, the link prediction module 615 predicts one or more linkages between the one or more features.

Once the linkage between each pair of the 45 features is identified, the inputs are processed to the launch screen selector 620 to identify a launch screen feature or a start screen feature among the 6 features. Alternatively, the inputs are processed simultaneously by the launch screen selector 620 along with the link prediction module 615.

The launch screen selector based on the inputs provided selects and/or recommends the start screen feature for the application. The output from the link prediction model 615 is then provided to the postprocess module 625 to identify any missing linkages between the 6 features.

The output from the postprocess module 625 includes a final linkage between the one or more features and a prototype of the application is generated using the postprocess module 625 output. For example, the splash screen 902 may navigate to the landing page 906 which gives information about application. The splash screen 902 also navigate to the email login 904 to enter the login credentials of the user. When the user enters the login details and clicks the login button, the email login 904 navigates to the phone verification 908. When the clicks on forgot password, the email login 904 navigates to the forgot password 910. The phone verification 908 takes inputs from the OTP received on the user's electronic device such as mobile phone. After the user enters the OTP and clicks on NEXT button, the phone verification 908 page navigates to the profile/bio 912. The generated prototype of the application having the screen flow view is shown in FIG. 9A.

Referring to FIG. 9B, FIG. 9B is an illustration of a subset of screen flow view of FIG. 9A. The screen flow view as shown in FIG. 9B illustrates a linkage between “Phone Verification” 908 feature and other features such as the Email Login 904 and the Profile/Bio 912.

The linkage between the different features is shown by arrows connecting the different features. By selecting the Features “Phone Verification” 908 from FIG. 9A, the linkage for the Phone Verification feature 910 with other features is highlighted and shown as in FIG. 9B.

The linkage between the “Phone Verification” feature 908 and other features such as the Email Login 904 and the profile/bio 912 is generated by one of the Link prediction module 615 and the postprocess module 625.

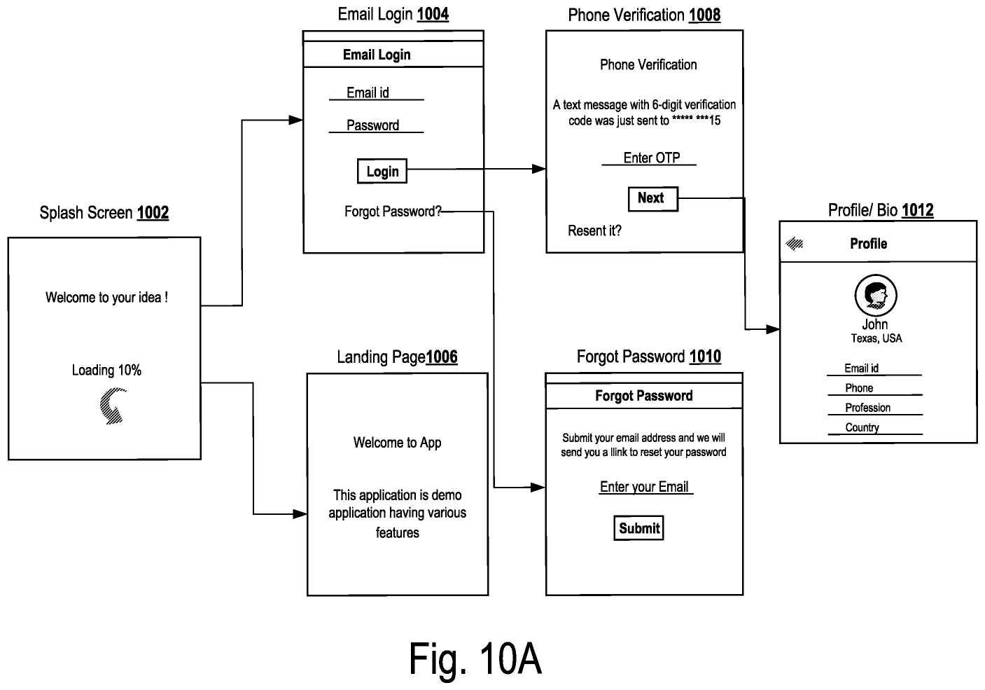

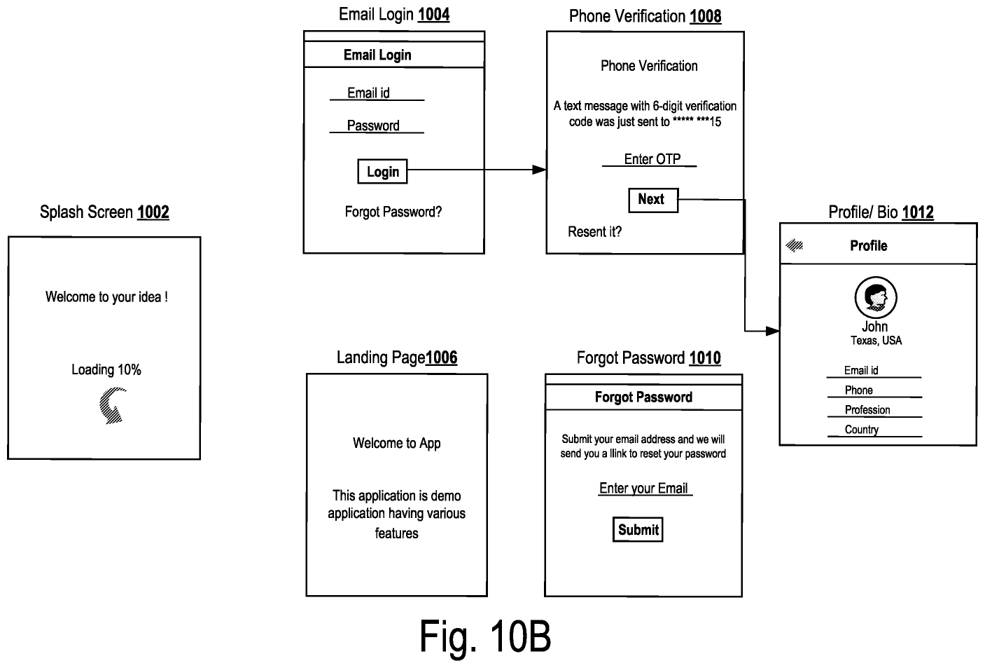

Referring to FIG. 10A, FIG. 10A is an illustration of a screen flow view of an exemplary application for the web platform. The screen flow view is an output of the prototype generation system 600. The customer has selected 6 features such as a splash screen 1002, an email login 1004, a landing page 1006, a phone verification 1008, a forgot password 1010, and a profile/bio 1012 for building an application. One or more inputs from the customer as a buildcard having 6 features and historical data from the database coupled to the BKG are provided to the prototype generation system 600. Initially, the inputs are provided to the link prediction module 615 of the prototype generation system 600 to predict a linkage between each pair of the 6 features. The link prediction module 615 initially selects a machine learning model that is required to predict the linkage between each pair of the 6 features. Upon selecting the machine learning model, the link prediction module 615 predicts one or more linkages between the one or more features.

Once the linkage between each pair of the 6 features is identified, the inputs are processed to the launch screen selector 620 to identify a launch screen feature or a start screen feature among the 6 features. Alternatively, the inputs are processed simultaneously by the launch screen selector 620 along with the link prediction module 615.

The launch screen selector based on the inputs provided selects and/or recommends the start screen feature for the application. The output from the link prediction model 615 is then provided to the postprocess module 625 to identify any missing linkages between the 6 features.

The output from the postprocess module 625 includes a final linkage between the one or more features and a prototype of the application is generated using the postprocess module 625 output. For example, the splash screen 1002 may navigate to the landing page 1006 which gives information about application. The splash screen 1002 also navigate to the email login 1004 to enter the login credentials of the user. When the user enters the login details and clicks the login button, the email login 1004 navigates to the phone verification 1008. When the clicks on forgot password, the email login 1004 navigates to the forgot password 1010. The phone verification 1008 takes inputs from the OTP received on the user's electronic device such as mobile phone. After the user enters the OTP and clicks on NEXT button, the phone verification 1008 page navigates to the profile/bio 1012. The generated prototype of the application having the screen flow view is shown in FIG. 10A.

Referring to FIG. 10B, FIG. 10B is an illustration of a subset of screen flow view of FIG. 10A. The screen flow view as shown in FIG. 10B illustrates a linkage between “Phone Verification” feature 1008 and other features such as Email Login 1004 and a Profile/Bio 1012.

The linkage between the different features is shown by arrows connecting the different features. By selecting the Features “Phone Verification” 1008 from FIG. 10A, the linkage for the Phone Verification feature 1008 with other features is highlighted and shown as in FIG. 10B.

The linkage between the “Phone verification” feature 1008 and other features such as Email Login 1004 and the profile/bio 1012 is generated by one of the Link prediction module 615 and the postprocess module 625.

Referring to FIG. 11A, FIG. 11A is an illustration of a prototype represented as a graph for an exemplary application. The graph shows the output of the prototype generation system 600. The customer has selected 45 features for building an application. One or more inputs from the customer as a buildcard having 45 features and historical data from the database coupled to the BKG are provided to the prototype generation system 600.

Initially, the inputs are provided to the link prediction module 615 of the prototype generation system 600 to predict a linkage between each pair of the 45 features. The link prediction module 615 initially selects a machine learning model that is required to predict the linkage between each pair of the 45 features. Upon selecting the machine learning model, the link prediction module 615 predicts one or more linkages between the one or more features.

Once the linkage between each pair of the 45 features is identified, the inputs are processed to the launch screen selector 620 to identify a launch screen feature or a start screen feature among the 45 features. Alternatively, the inputs are processed simultaneously by the launch screen selector 620 along with the link prediction module 615. The launch screen selector based on the inputs provided selects and/or recommends the start screen feature for the application.

The output from the link prediction module 615 includes the linkage between the one or more features and a prototype of the application is generated having the graph view as shown in FIG. 11A.

Referring to FIG. 11B, FIG. 11B is an illustration of a prototype represented as a graph for an exemplary application. As shown in FIG. 11A, some of the features (i.e., barcode scanner 1110) may not be fully connected using the link prediction module 615 of FIG. 6.

In order to get the fully connected flow, the output from the link prediction module 615 is provided to the postprocess module 625 to identify any missing linkages and to get fully connected flow. In the first step, the postprocess module 625 classifies a list of features selected for the application development, as unconnected features and connected features.

Later, the post process module 625 identifies one or more potential hotspots in the unconnected features and predicts the linkage for the unconnected features with the connected features based on the one or more identified potential hotspots to get fully connected graph as shown in FIG. 11B.

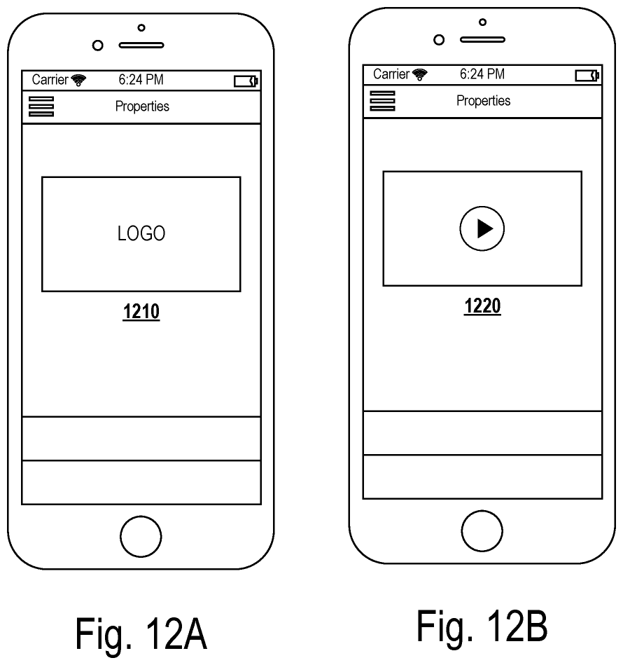

Referring to FIGS. 12A-12B, FIGS. 12A-12B are illustrations of launch screens for two different exemplary applications. In an example scenario, assume that the customer has selected 45 features for building an application. One or more inputs from the customer as a buildcard having 45 features and historical data from the database coupled to the BKG are provided to the prototype generation system 600. Initially, the inputs are provided to the link prediction module 615 of the prototype generation system 600 to predict a linkage between each pair of the 45 features. The link prediction module 615 initially selects a machine learning model that is required to predict the linkage between each pair of the 45 features. Upon selecting the machine learning model, the link prediction module 615 predicts one or more linkages between the one or more features.

Once the linkage between each pair of the 45 features is identified, the inputs are processed to the launch screen selector 620 to identify a launch screen feature or a start screen feature among the 45 features. Alternatively, the inputs are processed simultaneously by the launch screen selector 620 along with the link prediction module 615.

The launch screen selector based on the inputs provided selects and/or recommends the start screen feature for the application. In order to recommend and/or select the one or more launch screens or the start screen feature for the application, the launch screen selector 620 is configured to receive a hierarchical relationship between the one or more features from the link prediction module 615. The launch screen selector 620 is then configured to identify a type of application based on the application template. Upon identifying the type of application, the launch screen selector 620 is configured to input the type of application and the one or more features to a first machine learning model and recommend the launch screen for the application based on an output of the first machine learning model. By implementing the above process, the launch screen selector 620 selects/recommends the start screen feature having a feature displaying logo of the company/individual 1210 for an exemplary application as shown in FIG. 12A.

Similarly, for another exemplary application, the launch screen selector 620 is configured to select/recommend the start screen feature having a feature displaying videos of the company/individual 1220 as shown in FIG. 12B.

The term function, as used herein may refer to any sequence of instructions that perform a task. The term function, as used herein, may refer to any function, subroutine, module, class, entity, component, or the like in a software environment.

Many variations may be made to the embodiments of the software project described herein. All variations, including combinations of variations, are intended to be included within the scope of this disclosure. The description of the embodiments herein can be practiced in many ways. Any terminology used herein should not be construed as restricting the features or aspects of the disclosed subject matter. The scope should instead be construed in accordance with the appended claims.

1. A method for generating an instant application, the method comprising:
receiving a selection of one or more features and an application template;
determining a linkage between each pair of features of the one or more selected features;
processing the one or more selected features based on the determined linkage; and
generating the instant application based on the processing and using the application template.

2. The method of claim 1, wherein processing the one or more selected features based on the determined linkage comprises:
classifying the one or more features as unconnected features and connected features;
identifying one or more potential hotspots in the unconnected features; and
predicting the linkage for the unconnected features with the connected features based on the one or more identified potential hotspots.

3. The method of claim 2, wherein predicting the linkage for the unconnected features with the connected features comprises:
retrieving one or more clickable items mapped to the identified one or more potential hotspots, wherein the one or more clickable items are included in the one or more features; and
predicting the linkage for the unconnected features with the connected features based on the retrieved one or more clickable items.

4. The method of claim 2, wherein predicting the linkage for the unconnected features with the connected features comprises:
inputting the identified one or more potential hotspots to a first machine learning model;
estimating one or more clickable items as an output of the first machine learning model, wherein the one or more clickable items are included in the one or more features; and
predicting the linkage for the unconnected features with the connected features based on the estimated one or more clickable items.

5. The method of claim 1, further comprises recommending one or more launch screens for the application based on the application template.

6. The method of claim 1, wherein determining the linkage between each pair of features of the one or more selected features comprises:
retrieving historical data from a database;
selecting a machine learning model from a plurality of machine learning models, wherein each of the plurality of machine learning models includes a Light Gradient Boosting model;
inputting the historical data and one or more inputs to the selected machine learning model; and
determining the linkage between each pair of features based on an output of the selected machine learning model.

7. The method of claim 6, wherein selecting the machine learning model from the plurality of machine learning models comprises:
inputting the one or more inputs and the retrieved historical data to each of the plurality of machine learning model by assigning a weightage factor to each of the one or more inputs;
determining a value of one or more parameters, wherein at least one parameter of the one or more parameters includes a F1 score; and
selecting the machine learning model based on values of the one or more parameters.

8. A computer system to generate an instant application, the system comprising:
a memory; and
a processor coupled to the memory and configured to:
receive a selection of one or more features and an application template;
determine a linkage between each pair of features of the one or more selected features;
process the one or more selected features based on the determined linkage; and
generate the instant application based on the processing and using the application template.

9. The system of claim 8, wherein to process the one or more selected features based on the determined linkage, the processor is configured to:
classify the one or more features as unconnected features and connected features;
identify one or more potential hotspots in the unconnected features; and
predict the linkage for the unconnected features with the connected features based on the one or more identified potential hotspots.

10. The system of claim 9, wherein to predict the linkage for the unconnected features with the connected features, the processor is configured to:
retrieve one or more clickable items mapped to the identified one or more potential hotspots, wherein the one or more clickable items are included in the one or more features; and
predict the linkage for the one or more unconnected features with the connected features based on the retrieved one or more clickable items.

11. The system of claim 10, wherein to predict the linkage for the unconnected features with the connected features, the processor is configured to:
input the identified one or more potential hotspots to a first machine learning model;
estimate one or more clickable items as an output of the first machine learning model, wherein the one or more clickable items are included in the one or more features; and
predict the linkage for the unconnected features with the connected features based on the estimated one or more clickable items.

12. The system of claim 8, wherein the processor is further configured to recommend the one or more launch screens for the application based on the application template.

13. The system of claim 8, wherein to determine the linkage between each pair of features of the one or more selected features, the processor is configured to:
retrieve historical data from a database stored in the memory;
select a machine learning model from a plurality of machine learning models, wherein each of the plurality of machine learning models includes a Light Gradient Boosting model;
input the historical data and one or more inputs to the selected machine learning model; and
determine the linkage between each pair of features based on an output of the selected machine learning model.

14. The system of claim 13, wherein to select the machine learning model from the plurality of machine learning models, the processor is configured to:
input one or more inputs and the retrieved historical data to each of the plurality of machine learning model by assigning a weightage factor to each of the one or more inputs;
determine a value of one or more parameters, wherein at least one parameter of the one or more parameters includes a F1 score; and
select the machine learning model based on values of the one or more parameters.

15. A computer readable storage medium having data stored therein representing software executable by a computer, the software comprising instructions that, when executed, cause the computer readable storage medium to perform:
receiving a selection of one or more features and an application template;
determining a linkage between each pair of features of the one or more selected features;
processing the one or more selected features based on the determined linkage; and
generating an instant application based the processing and using the application template.

16. The computer readable storage medium of claim 15, wherein processing the one or more selected features based on the determined linkage comprises:
classifying the one or more features as unconnected features and connected features;
identifying one or more potential hotspots in the unconnected features; and
predicting the linkage for the unconnected features with the connected features based on the one or more identified potential hotspots.

17. The computer readable storage medium of claim 16, wherein predicting the linkage for the unconnected features with the connected features comprises:
retrieving one or more clickable items mapped to the identified one or more potential hotspots, wherein the one or more clickable items are included in the one or more features; and
predicting the linkage for the unconnected features with the connected features based on the retrieved one or more clickable items.

18. The computer readable storage medium of claim 15, wherein predicting the linkage for the one or more unconnected features with the one or more features comprises:
inputting the identified one or more potential hotspots to a first machine learning model;
estimating one or more clickable items as an output of the first machine learning model, wherein the one or more clickable items are included in the one or more features; and
predicting the linkage for the unconnected features with the connected features based on the estimated one or more clickable items.

19. The computer readable storage medium of claim 15, further comprises recommending one or more launch screens for the application based on the application template.

20. The computer readable storage medium of claim 15, wherein determining the linkage for each pair of features of the one or more selected features comprises:
retrieving historical data from a database;
selecting a machine learning model from a plurality of machine learning models, wherein each of the plurality of machine learning models includes a Light Gradient Boosting model;
inputting the historical data and one or more inputs to the selected machine learning model; and
determining the linkage between each pair of features based on an output of the selected machine learning model.
